(19) United States
(12) Patent Application Publication
(10) Pub. No.: US 2025/0059826 A1
(43) Pub. Date: Feb. 20, 2025

(54) DOUBLE-STRING ROLLING DEVICE

(71) Applicant: COTTAI LTD., Tainan City (TW)

(72) Inventor: Kuan-Ting Chen, Tainan City (TW)

(21) Appl. No.: 18/802,149

(22) Filed: Aug. 13, 2024

(30) Foreign Application Priority Data
Aug. 17, 2023 (TW) 112130982

(51) Int. Cl. E06B 9/322

(52) U.S. Cl. CPC E06B 9/322

(57) ABSTRACT

A double-string rolling device is installed on a roller blind and includes a first engagement unit, a second engagement unit and a first ratchet unit mounted on two ends of the first engagement unit, a second ratchet unit mounted on the second engagement unit, a first disc and a second disc connected to the first engagement unit and the second engagement unit respectively, a first string and a second string wrapped around the first disc and the second disc respectively, and an elastic unit disposed between the first disc and the second disc. By pulling the first string and the second string, the first ratchet unit and the second ratchet unit respectively rotate in different directions to further unfold or fold a curtain of the roller blind. The first string and the second string restore to the original position automatically owing to resilience of the elastic unit.

### BACKGROUND OF THE INVENTION

### 1. Field of the Invention

The present invention relates to a rolling device, especially to a double-string rolling device with two-way movement.

### 2. Description of the Prior Arts

Roller blinds can be used to adjust indoor light and shade, prevent indoor temperature from being affected by the outdoors, provide heat and sound insulation, and have the advantages of easy cleaning and relatively low price. In addition, with curtains of different materials and colors, the user can decorate living environment and create different life styles according to different environmental spaces. Therefore, roller blinds with multiple usages and economic benefits are popular.

With reference to FIG. 1 and FIG. 2, the conventional roller blind 1 comprises a shaft 11, a curtain 12, a rolling unit 13, and a bead chain 14. The curtain 12 is mounted on the shaft 11, and the rolling unit 13 is mounted on an end of the shaft 11. The bead chain 14 is mounted in the rolling unit 13 and is connected to the curtain 12. The bead chain 14 circulates in the rolling unit 13, such that the rolling unit 13 rotates clockwise or counterclockwise by pulling the bead chain 14, and links the shaft 11 to rotate, thereby controlling the curtain 12 to hang down or roll up.

The double-pull design of the bead chain 14 of the roller blind 1 can control the curtain 12 with the downward pulling action, that is, by pulling down the bead chains 14 on different sides of the rolling unit 13, the curtain 12 can be moved downward or upward. However, the bead chain 14 must be arranged in a continuous and uninterrupted ring shape to circulate around the rolling unit 13, that is, the bead chain 14 is hung on the side of the roller blind 1 in a complete ring shape. In addition, the bead chain 14 usually has a certain length, which may easily cause children or pets to get entangled due to curiosity, leading to dangerous situations such as injury or suffocation and even death. This is not safe for use and needs to be improved.

### SUMMARY OF THE INVENTION

The main objective of the present invention is to provide a double-string rolling device that can effectively avoid entanglement and other incidents, thereby improving the safety of use. In addition, the double-string rolling device has a simple structure and can be directly installed on a roller blind, which is more economical.

The double-string rolling device is installed on a roller blind. The roller blind comprises a shaft and a curtain mounted on the shaft. The double-string rolling device is mounted on an end of the shaft to unfold or fold the curtain. The double-string rolling device comprises a driving assembly and a controlling assembly.

The driving assembly comprises a first engagement unit, a second engagement unit, a first ratchet unit, and a second ratchet unit. The second engagement unit is mounted on an end of the first engagement unit, and the first ratchet unit is sleeved on another end of the first engagement unit. The second ratchet unit is sleeved on an end of the second engagement unit. The first ratchet unit is able to rotate in a first rotating direction and the second ratchet unit is able to rotate in a second rotating direction. The first rotating direction is opposite to the second rotating direction.

The controlling assembly is connected to the driving assembly and comprises a shell, a first disc, a first string, a second disc, a second string, and a first elastic unit. The shell is connected to the shaft of the roller blind. The first disc is mounted in the shell and engaged with the first engagement unit. The first string is wrapped around the first disc. Similarly, the second disc is mounted in the shell and engaged with the second engagement unit. The second string is wrapped around the second disc. The first elastic unit is mounted between the first disc and the second disc.

The first string is connected to the first disc, such that the first engagement unit engaged with the first disc is driven, then driving the first ratchet unit to rotate. Similarly, the second string is connected to the second disc, such that the second engagement unit engaged with the second disc is driven, then driving the second ratchet unit to rotate. This controls the curtain to move up or down. When the first string and the second string are released, the first disc and the second disc are acted upon by the first elastic unit, thereby driving the first string and the second string to reset, so as to facilitate shortening of the first string and the second string. The shorter length of the first string and the second string can effectively avoid entanglement and other incidents, thereby improving the safety of use. In addition, the double-string rolling device has a simple structure and can be installed on a roller blind, which not only saves production costs but is also more economical.

Other objectives, advantages and novel features of the invention will become more apparent from the following detailed description when taken in conjunction with the accompanying drawings.

### BRIEF DESCRIPTION OF THE DRAWINGS

FIG. 1 is a front view of a roller blind in accordance with the prior art;

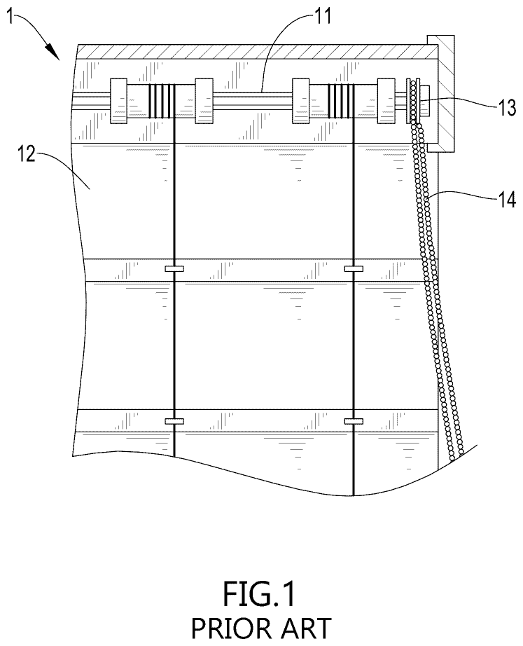

FIG. 2 is a side view of the roller blind in FIG. 1, shown in the movement state;

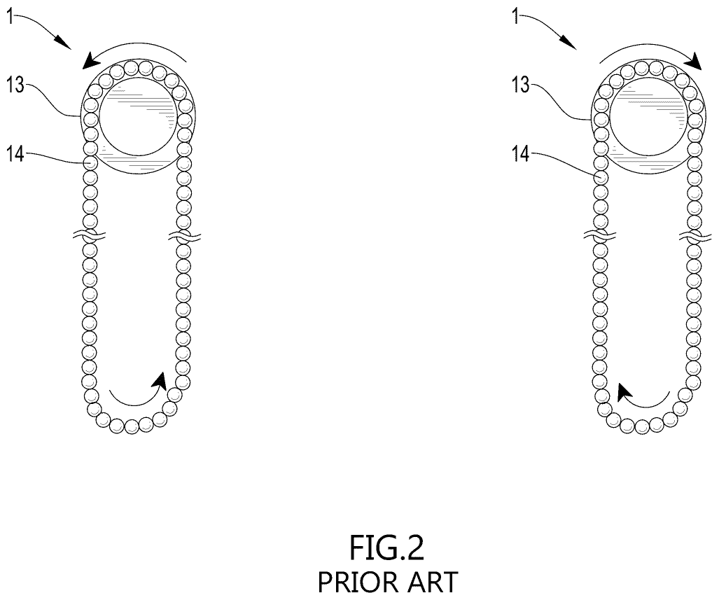

FIG. 3 is a front view of a double-string rolling device mounted on a roller blind in accordance with the present invention;

FIG. 4 is an exploded view of the double-string rolling device in FIG. 3;

FIG. 5 is a side view of the double-string rolling device in FIG. 3, shown in the movement state;

FIG. 6 is a sectional view of the double-string rolling device in FIG. 3;

FIG. 7 is a sectional view of the double-string rolling across line 7-7 in FIG. 6;

FIG. 8 is a sectional view of the double-string rolling device across line 8-8 in FIG. 6.

### DETAILED DESCRIPTION OF THE PREFERRED EMBODIMENTS

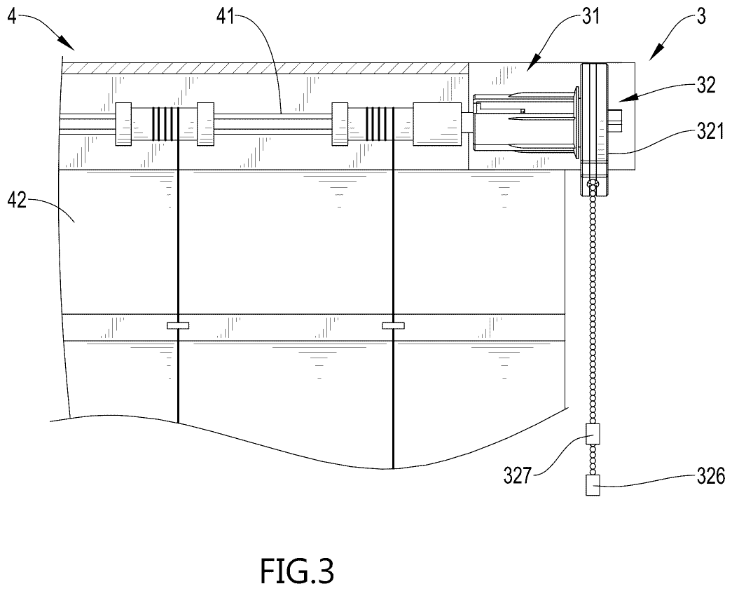

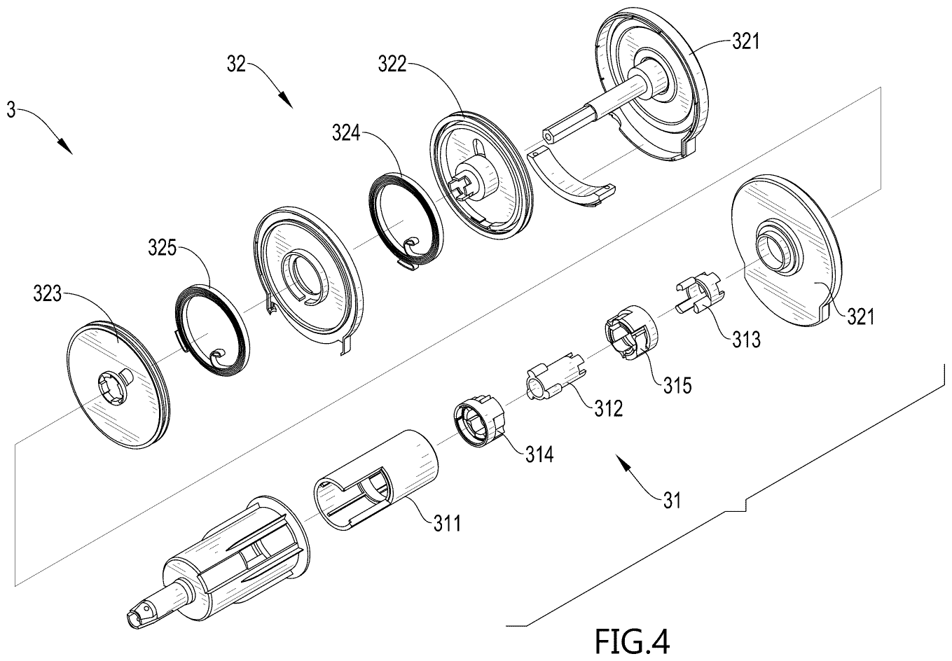

With reference to FIG. 3, a double-string rolling device 3 in accordance with the present invention is configured to be installed on a roller blind 4. The roller blind 4 includes a shaft 41 and a curtain 42. The curtain 42 is connected to the shaft 41 and can be curled up and folded in the shaft 41. The double-string rolling device 3 is mounted to an end of the shaft 41 and can rotate with the shaft 41 to unfold or fold the curtain 42. With reference to FIG. 4, the double-string rolling device 3 comprises a driving assembly 31 and a controlling assembly 32. The driving assembly 31 is connected to the shaft 41, and the controlling assembly 32 can control the movement of the driving assembly 31.

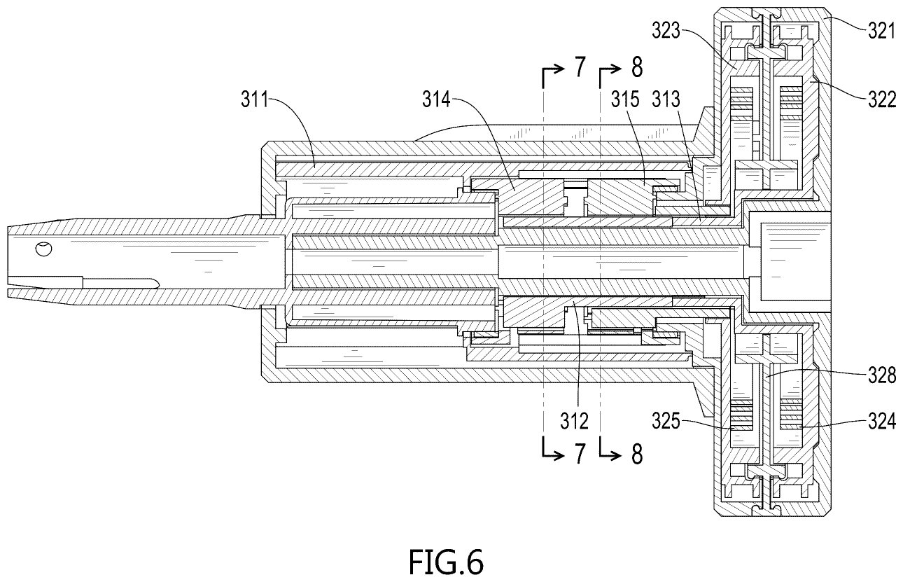

With reference to FIG. 4 to FIG. 6, the driving assembly 31 comprises a main unit 311, a first engagement unit 312, a second engagement unit 313, a first ratchet unit 314, and a second ratchet unit 315. The first engagement unit 312 is mounted in the main unit 311. The second engagement unit 313 is securely mounted on an end of the first engagement unit 312. The first ratchet unit 314 is mounted on and engaged with another end of the first engagement unit 312. The second ratchet unit 315 is mounted on and engaged with the second engagement unit 313. The first ratchet unit 314 and the second ratchet unit 315 are mounted opposite each other.

The controlling assembly 32 comprises a shell 321, a first disc 322, a second disc 323, a first elastic unit 324, a second elastic unit 325, a first string 326, a second string 327, and a division unit 328. The first disc 322 is mounted in the shell 321 and connected to the first engagement unit 312. The second disc 323 is mounted in the shell 321 and connected to the second engagement unit 313. The first elastic unit 324 and the second elastic unit 325 are mounted between the first disc 322 and the second disc 323. The first string 326 is wrapped around the first disc 322 and the second string 327 is wrapped around the second disc 323. The division unit 328 is mounted between the first elastic unit 324 and the second elastic unit 325. The first elastic unit 324 connects to the first disc 322 and the division unit 328. Similarly, the second elastic unit 325 connects to the second disc 323 and the division unit 328. The first string 326 and the second string 327 are dangled from two respective sides of the shell 321. The first string 326 and the second string 327 are restricted by the first elastic unit 324 and the second elastic unit 325. When there is no external force pulling, the first string 326 and the second string 327 will be maintained at a fixed length.

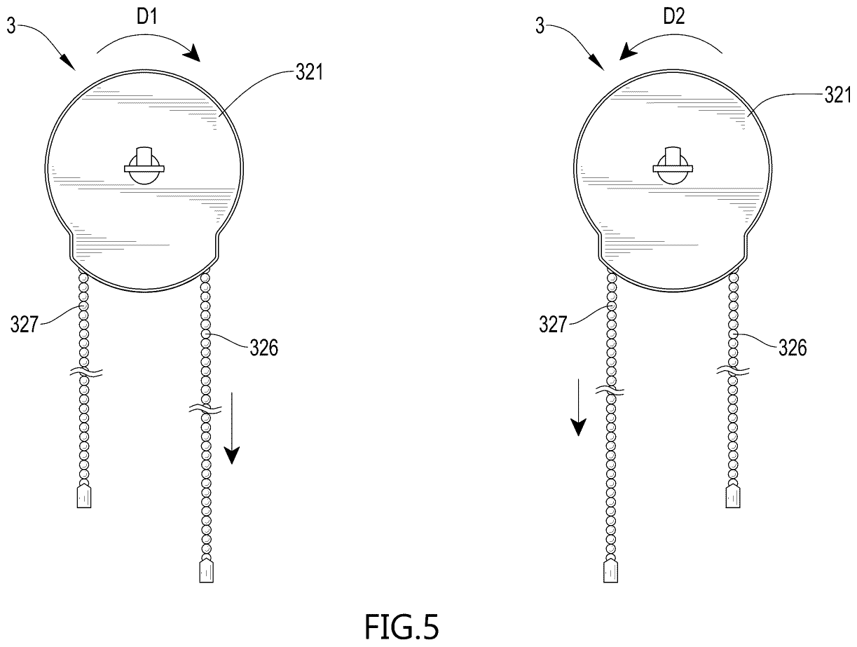

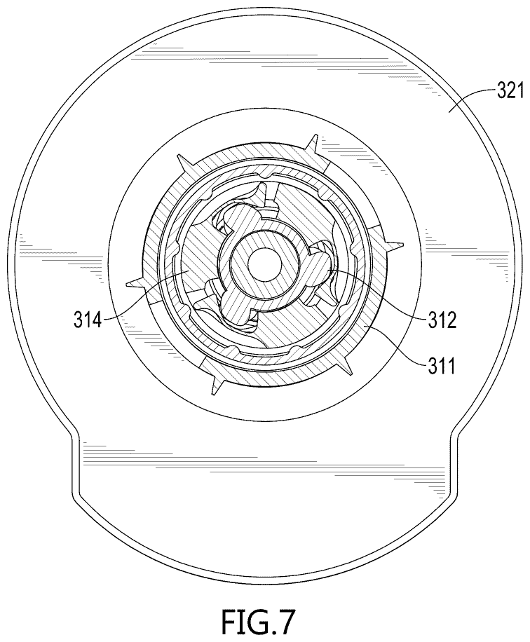

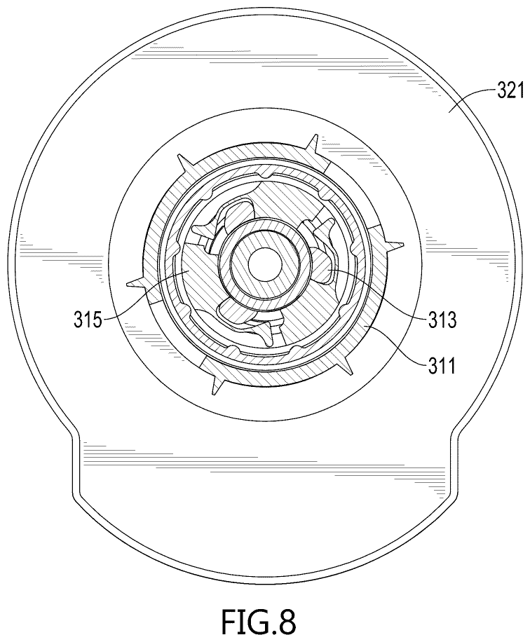

With reference to FIG. 5, FIG. 7, and FIG. 8, the first ratchet unit 314 and the second ratchet unit 315 can only rotate in a single direction respectively. The first ratchet unit 314 can only rotate in a first rotating direction D1, and the second ratchet unit 315 can only rotate in a second rotating direction D2. The first rotating direction D1 and the second rotating direction D2 are opposite to each other. In this embodiment, the first rotating direction D1 is a forward direction, and the second rotating direction D2 is a reverse direction. The first string 326 and the second string 327 are two independent strings in this embodiment, and an end of the first string 326 away from the shell 321 is not connected to an end of the second string 327 away from the shell 321.

With reference to FIG. 3, FIG. 4, and FIG. 5, when installing the double-string rolling device 3, it is only necessary to assemble and fix the driving assembly 31 and the controlling assembly 32 of the double-string rolling device 3, and mount the shaft 41 of the roller blind 4 through the driving assembly 31 and the controlling assembly 32 respectively to engage the shaft 41 and the shell 321. In this way, the shaft 41 can be rotated through the double-string rolling device 3 to unfold or fold the curtain 42. The roller blind 4 can be any cord-type curtain widely used in the market, that is, the double-string rolling device 3 can be directly applied to the common roller blind 4, saving the cost of replacing the entire set of roller blinds 4, and can effectively enhance consumers' purchasing intention.

With reference to FIG. 4 and FIG. 5, after the double-string rolling device 3 is installed, through pulling the first string 326 downward, the first disc 322 is driven by the first string 326 to rotate. At this time, the first disc 322 rotates synchronously with the first engagement unit 312, such that the first ratchet unit 314 is acted upon by the first engagement unit 312 and rotates forward in the first rotation direction D1, thereby driving the shaft 41 to rotate forward to unfold downward and hang the curtain 42. When the curtain 42 is lowered to the desired position, the user stops pulling and releases the first string 326. At this time, due to the restoring force of the first elastic unit 324, the first elastic unit 324 will drive the first disc 322 to rotate back to the original position of the first disc 322, thereby causing the first string 326 to rise and restore to the original position of the first string 326.

Similarly, by pulling the second string 327 downward, the second disc 323 is driven by the second string 327 to rotate. At this time, the second disc 323 rotates synchronously with the second engagement unit 313, such that the second ratchet unit 314 is acted upon by the second engagement unit 313 and rotates forward in the second rotation direction D2, thereby driving the shaft 41 to rotate forward to fold upward and hang the curtain 42. When the curtain 42 is up to the desired position, the user stops pulling and releases the second string 327. At this time, due to the restoring force of the second elastic unit 325, the second elastic unit 325 will drive the second disc 323 to rotate back to the original position of the second disc 323, thereby causing the second string 327 to rise and restore to the original position of the second string 327. Therefore, the first string 326 and the second string 327 are restricted by the first elastic unit 324 and the second elastic unit 325 and can be maintained at a fixed length when not in use. In other words, the first string 326 and the second string 327 are at a certain distance from the ground and will not hang on the ground, making it difficult for children or pets to touch and pull the first string 326 and the second string 327. In addition, the end of the first string 326 away from the shell 321 is not connected to the end of the second string 327 away from the shell 321. Therefore, it prevents the first string 326 and the second string 327 from snagging or wrapping around the neck, greatly improving the safety of use. Further, the double-string rolling device 3 has a simple structure, is easy and fast to install, can effectively reduce production costs, and is more economical.

To summarize the above, the first string 326 is connected to the first disc 322, such that the first engagement unit 312 engaged with the first disc 322 is driven, then driving the first ratchet unit 314 to rotate. Similarly, the second string 327 is connected to the second disc 323, such that the second engagement unit 313 engaged with the second disc 323 is driven, then driving the second ratchet unit 315 to rotate. This controls the curtain 42 to move up or down. When the first string 326 and the second string 327 are released, the first disc 322 and the second disc 323 are acted upon by the first elastic unit 324 and the second elastic unit 325, thereby driving the first string 326 and the second string 327 to reset, so as to facilitate shortening of the first string 326 and the second string 327. The shorter length of the first string 326 and the second string 327 can effectively avoid entanglement and other incidents, thereby improving the safety of use. In addition, the double-string rolling device 3 has a simple structure and can be installed on a roller blind, which not only saves production costs but is also more economical.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A double-string rolling device mounted on a roller blind; the roller blind including a shaft and a curtain mounted on the shaft; the double-string rolling device mounted on an end of the shaft to unfold or fold the curtain; the double-string rolling device comprising:
a driving assembly comprising:
a first engagement unit;
a second engagement unit mounted on an end of the first engagement unit;
a first ratchet unit sleeved on another end of the first engagement unit; the first ratchet unit configured to rotate in a first rotating direction; and
a second ratchet unit sleeved on the second engagement unit; the second ratchet unit configured to rotate in a second rotating direction; the first rotating direction being opposite to the second rotating direction; and
a controlling assembly connected to the driving assembly and comprising:
a shell connected to the shaft of the roller blind and thus the shaft being secured;
a first disc mounted in the shell and engaged with the first engagement unit;
a first string wrapped around the first disc;
a second disc mounted in the shell and engaged with the second engagement unit;
a second string wrapped around the second disc; and
a first elastic unit mounted between the first disc and the second disc.

2. The double-string rolling device as claimed in claim 1, wherein the controlling assembly comprises:
a second elastic unit mounted between the first disc and the second disc; and
a division unit mounted between the first elastic unit and the second elastic unit.
